(19) United States
(12) Patent Application Publication
(10) Pub. No.: US 2026/0329019 A1
(43) Pub. Date: Oct. 22, 2026

(54) FIBER OPTIC CONNECTORS AND CABLE ANCHORING SYSTEMS FOR FIBER OPTIC CONNECTORS

(71) Applicant: CommScope Technologies LLC, Hickory, NC (US)

(72) Inventors: Yu LU, Eden Prairie, MN (US); Ryan KOSTECKA, Waconia, MN (US); Ponharith NHEP, Savage, MN (US)

(73) Assignee: CommScope Technologies LLC, Hickory, NC (US)

(21) Appl. No.: 19/107,747

(22) PCT Filed: Sep. 1, 2023
(86) PCT No.: PCT/US2023/073360

§ 371 Date: Feb. 28, 2025

Related U.S. Application Data
(60) Provisional application No. 63/403,643, filed on Sep. 2, 2022.

(51) Int. Cl. G02B 6/38

(52) U.S. Cl. CPC G02B 6/3887

(57) ABSTRACT

The present disclosure also relate to fiber optic connectors having connector core housings that can accommodate different cable anchoring configurations. Different types of end caps and clamps can be used with the connector core housings to effectively anchor different types of fiber optic cables to the connector core housings.

### CROSS-REFERENCE TO RELATED APPLICATIONS

This application is being filed on Sep. 1, 2023, as a PCT International application and claims the benefit of and priority to U.S. Provisional Application No. 63/403,643, filed Sep. 2, 2022, the disclosure of which is hereby incorporated by reference in its entirety.

### TECHNICAL FIELD

The present disclosure relates generally to fiber optic connectors. More particularly, the present disclosure relates to fiber optic connectors and configurations for anchoring fiber optic cables to fiber optic connectors.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288 and 8,556,520.

It will be appreciated that a number of different types of ruggedized fiber optic connectors are available for outside environmental use. PCT International Publication No. WO2015/028433 discloses a system for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter. Other systems are disclosed by PCT International Publication Nos. WO2021/041305 and WO2020/236512.

### SUMMARY

Aspects of the present disclosure relate to different cable anchoring configurations for securing different styles of fiber-optic cables to a fiber optic connector. Aspects of the present disclosure also relate to fiber optic connectors having main connector bodies that can accommodate different cable anchoring configurations.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 is an exploded view of an example fiber optic connector in accordance with the principles of the present disclosure;

FIG. 2 is an assembled perspective view of the fiber optic connector of FIG. 1;

FIG. 3 is cross-sectional view cut lengthwise through the fiber optic connector of FIG. 2 along a first cross-sectional plane;

FIG. 4 is cross-sectional view cut lengthwise through the fiber optic connector of FIG. 2 along a second cross-sectional plane rotated ninety degrees with respect to the first cross-sectional plane;

FIG. 5 is a perspective view of a front plug body of the fiber optic connector of FIG. 1;

FIG. 6 is another perspective view of the front plug body of the fiber optic connector of FIG. 1;

FIG. 7 depicts the front plug body of FIG. 5 improperly oriented relative to a main core body of the fiber optic connector of FIG. 1;

FIG. 8 depicts the front plug body of FIG. 5 properly oriented and installed on the main core body of the fiber optic connector of FIG. 1;

FIG. 9 is a perspective view of a rear spring stop of the fiber optic connector of FIG. 1;

FIG. 10 is a cross-sectional view depicting the rear spring stop of FIG. 9 latched within the main core body of the fiber optic connector of FIG. 1;

FIG. 11 is a perspective view of the main core body of the fiber optic connector of FIG. 1;

FIG. 12 is a rear perspective end view of the main core body of FIG. 11;

FIG. 13 depicts a first type of fiber optic cable anchored within the rear end of the main core body of the fiber optic connector of FIG. 1;

FIG. 14 depicts the fiber optic connector of FIG. 1 with an anchoring end cap installed in the rear end of the main core body for anchoring a second type of fiber optic cable to the rear end of the main core body;

FIG. 15 is an enlarged view of a portion of FIG. 14 depicting the anchoring end cap installed in the rear end of the main core body;

FIG. 16 is a cross-sectional view cut lengthwise through the fiber optic connector of FIG. 14;

FIG. 17 is a front perspective view of the anchoring end cap of FIG. 14;

FIG. 18 is a side view of the anchoring end cap of FIG. 17;

FIG. 19 is a rear perspective view of the anchoring end cap of FIG. 14;

FIG. 20 is a modified version of the anchoring end cap of FIG. 14;

FIG. 21 shows the anchoring end cap of FIG. 20 installed at the rear end of the main core body;

FIG. 22 is a perspective view of a cable anchoring clamp in accordance with the principles of the present disclosure adapted for use with a third type of fiber optic cable, the cable anchoring clamp is shown in a closed configuration;

FIG. 23 shows the cable anchoring clamp of FIG. 22 in an open configuration;

FIG. 24 is a cross-sectional view showing the cable anchoring clamp of FIGS. 22 and 23 positioned in the main core body of the fiber optic connector of FIG. 1;

FIG. 25 is another cross-sectional view showing the cable anchoring clamp of FIGS. 22 and 23 positioned in the main core body of the fiber optic connector of FIG. 1;

FIG. 26 is a perspective view of another anchoring end cap adapted to be installed in the rear end of the main core body of the fiber optic connector of FIG. 1 for anchoring a fourth type of fiber optic cable to the rear end of the main core body;

FIG. 27 is a front perspective view of the anchoring end cap of FIG. 26;

FIG. 28 is a rear perspective view of the anchoring end cap of FIG. 26;

FIG. 29 is a front perspective view of an alternative anchoring end cap for anchoring a fifth type of fiber optic cable to the rear end of the main core body;

FIG. 30 is a rear perspective view of the anchoring end cap of FIG. 29;

FIG. 31 is a transverse cross-sectional view of the first cable type to which the fiber optic connector of FIG. 1 can be mounted;

FIG. 32 is a transverse cross-sectional view of the second cable type to which the fiber optic connector of FIG. 1 can be mounted;

FIG. 33 is a transverse cross-sectional view of the third cable type to which the fiber optic connector of FIG. 1 can be mounted;

FIG. 34 is a transverse cross-sectional view of the fourth cable type to which the fiber optic connector of FIG. 1 can be mounted; and

FIG. 35 is a transverse cross-sectional view of the fifth cable type to which the fiber optic connector of FIG. 1 can be mounted.

### DETAILED DESCRIPTION

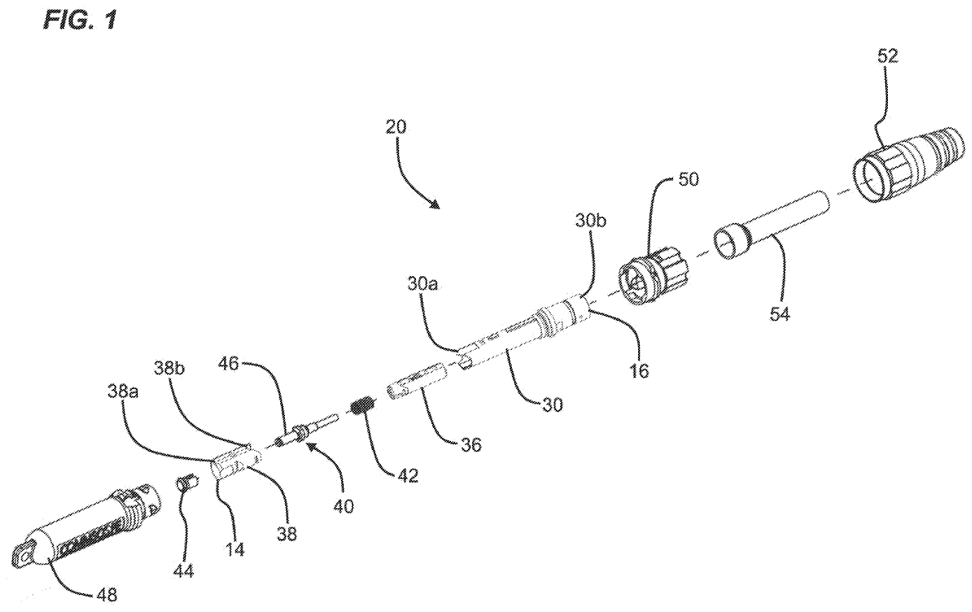

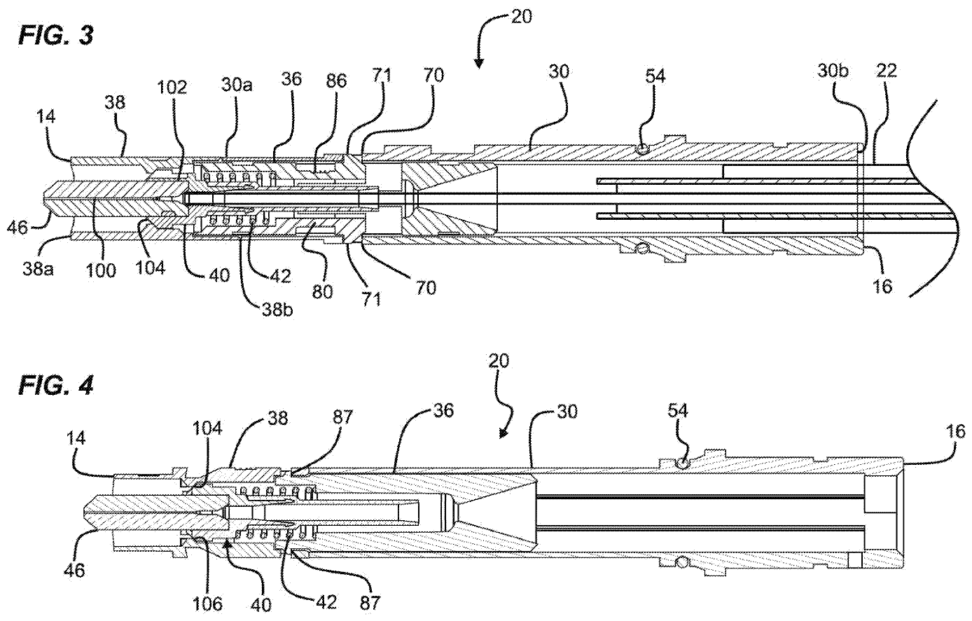

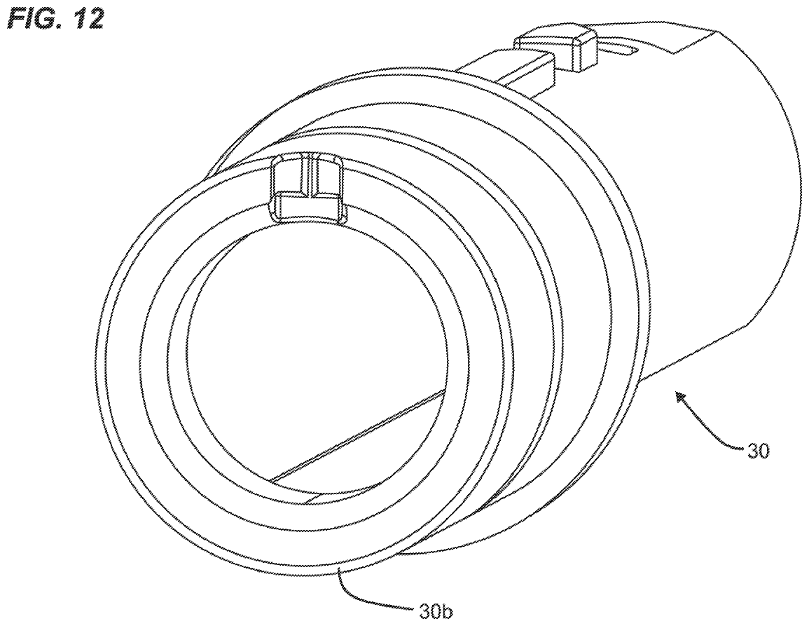

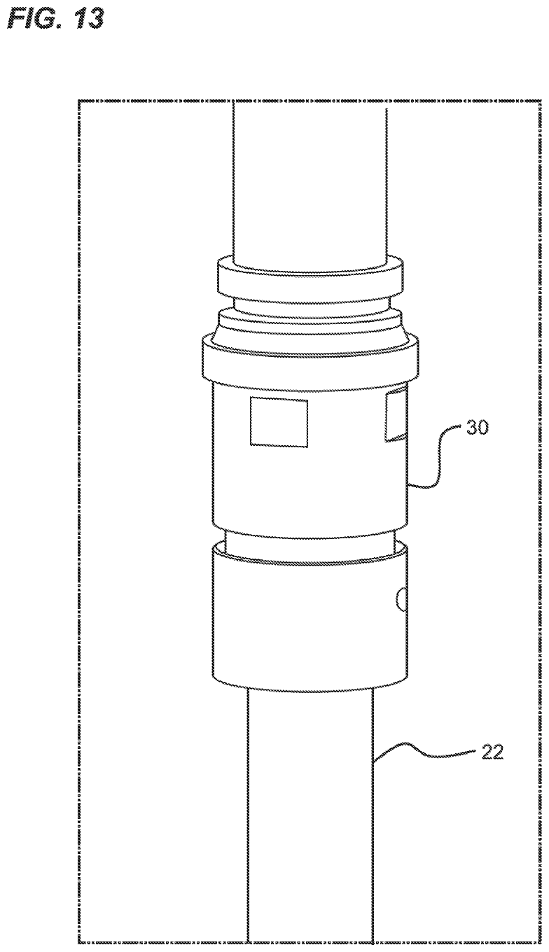

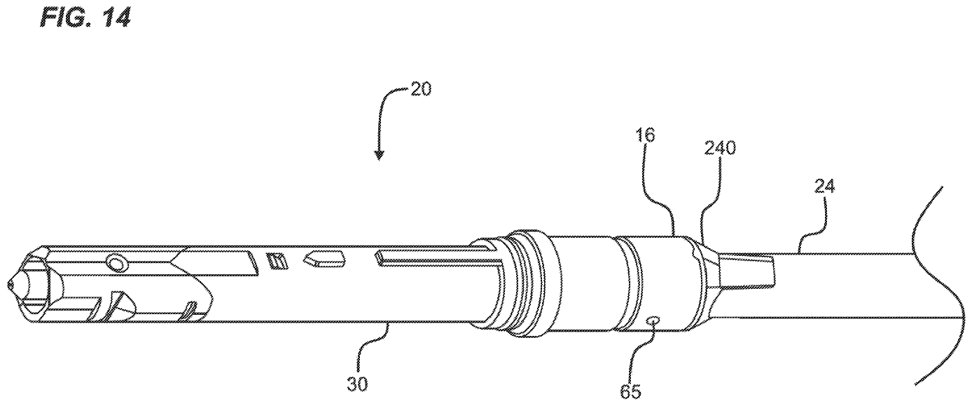

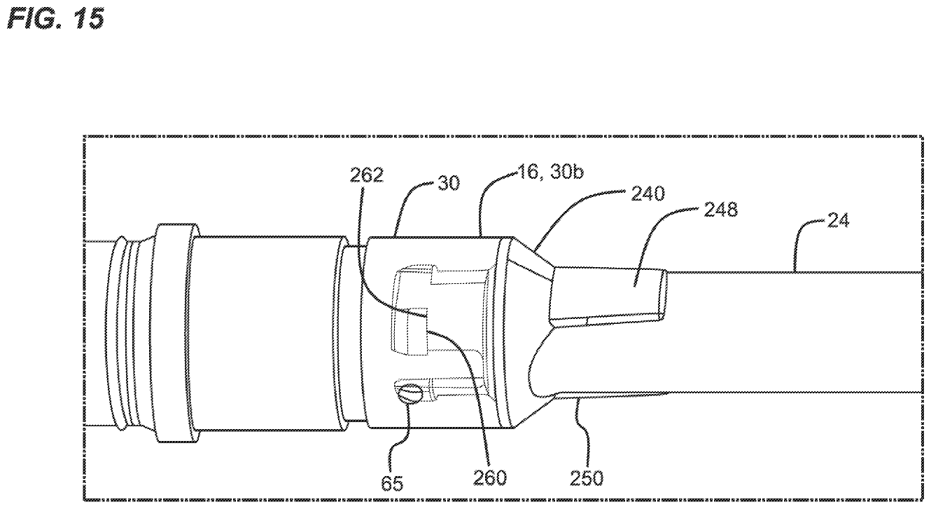

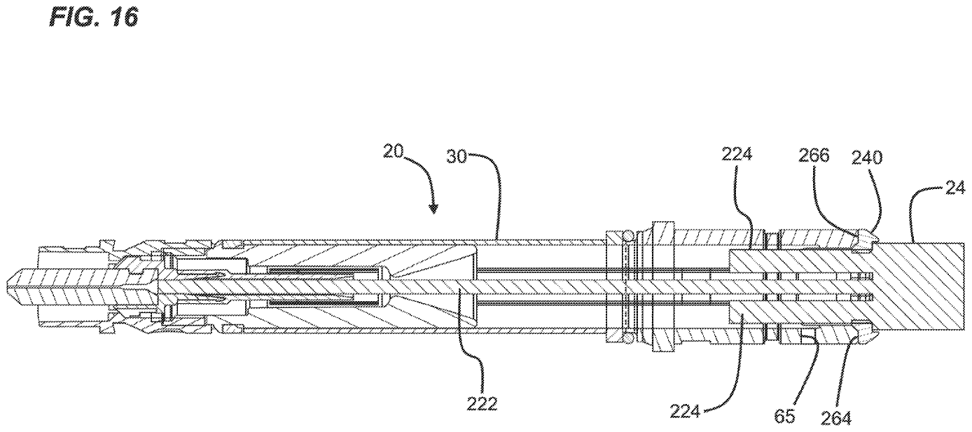

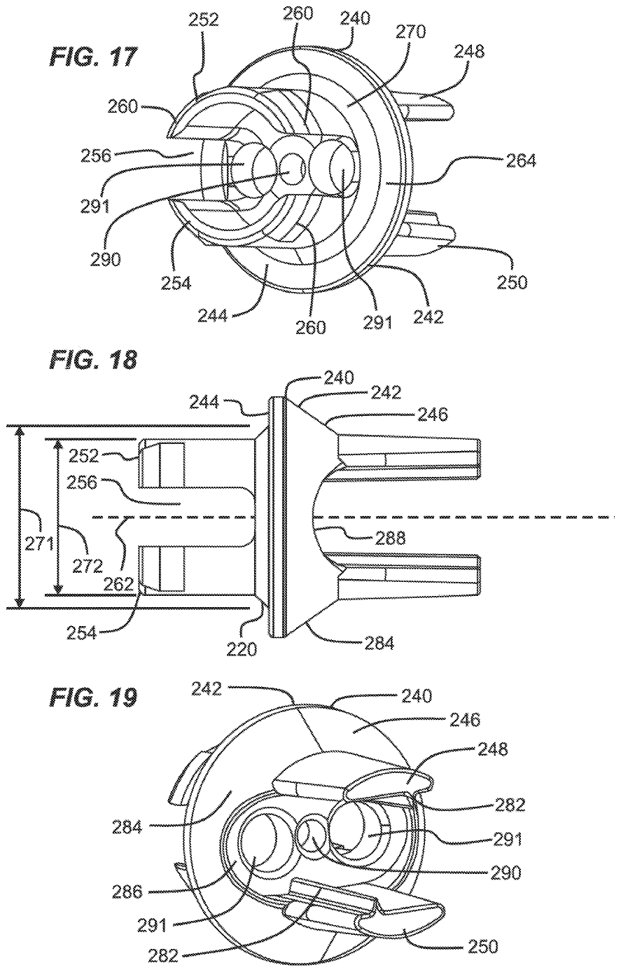

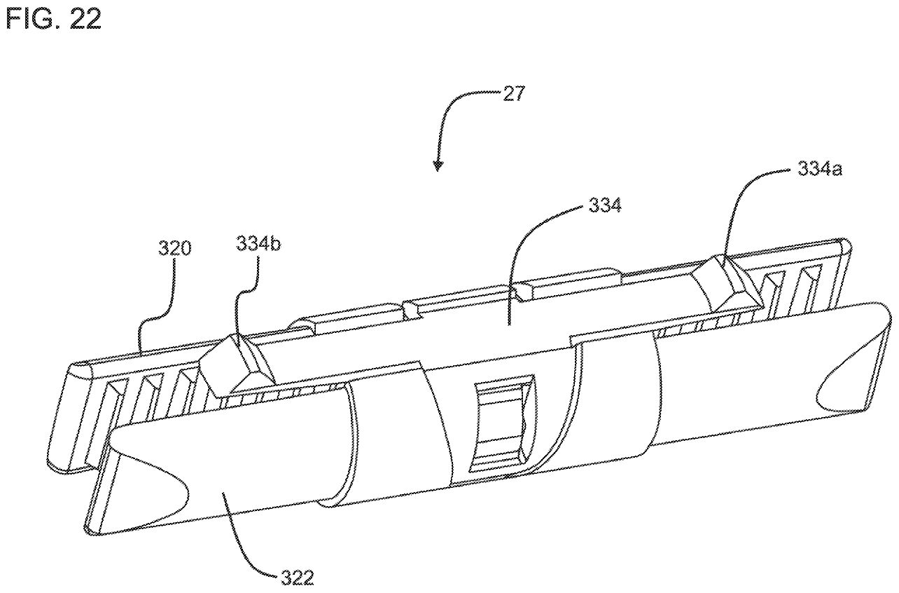

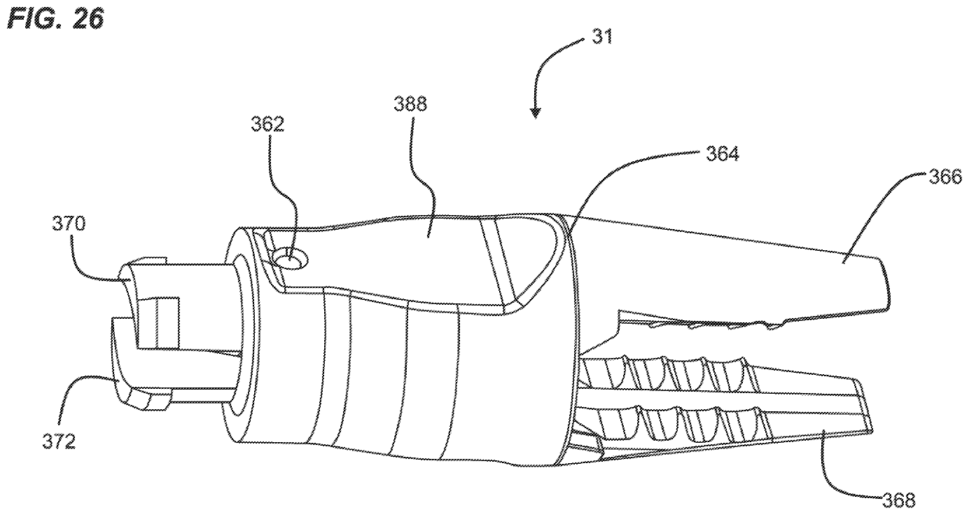

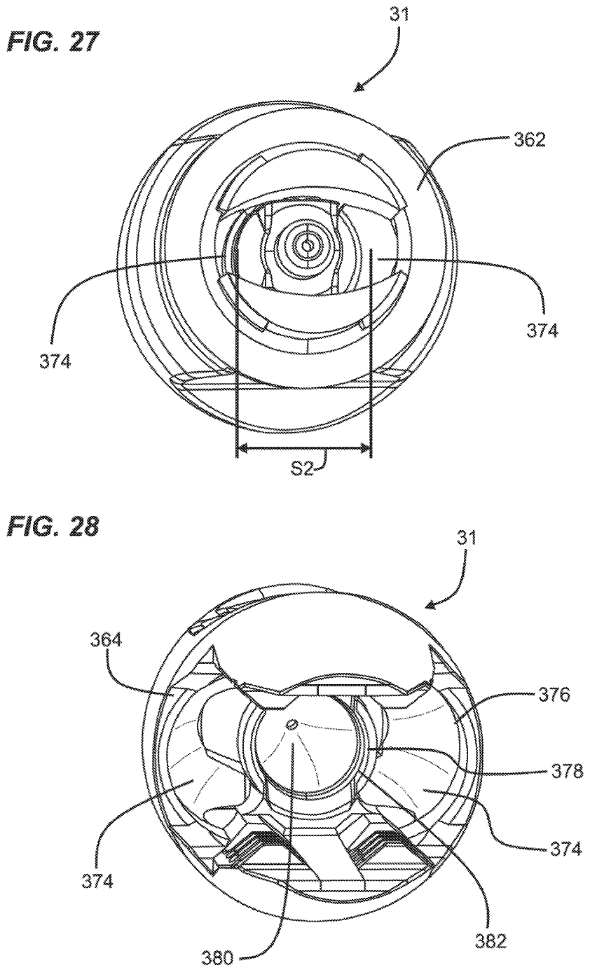

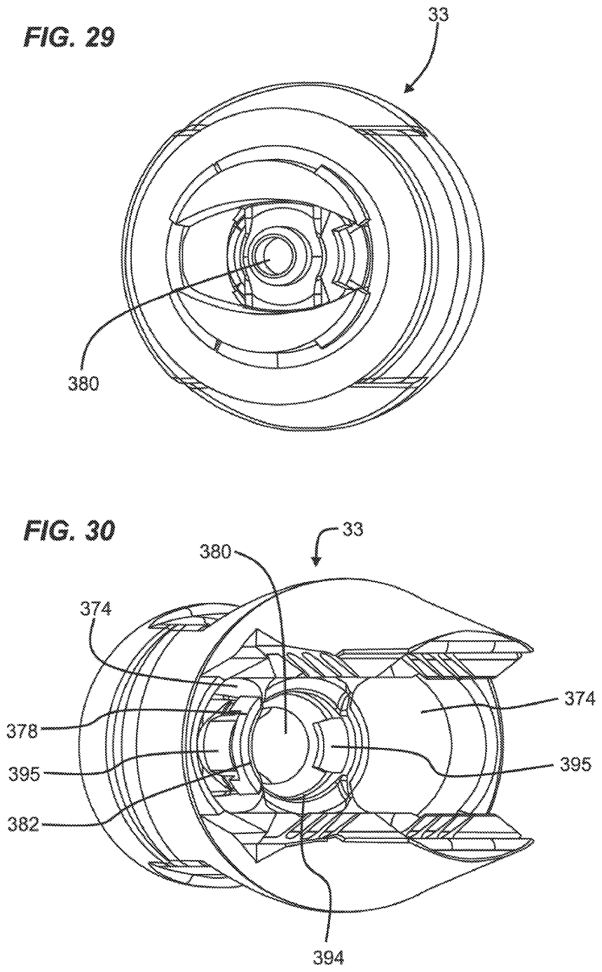

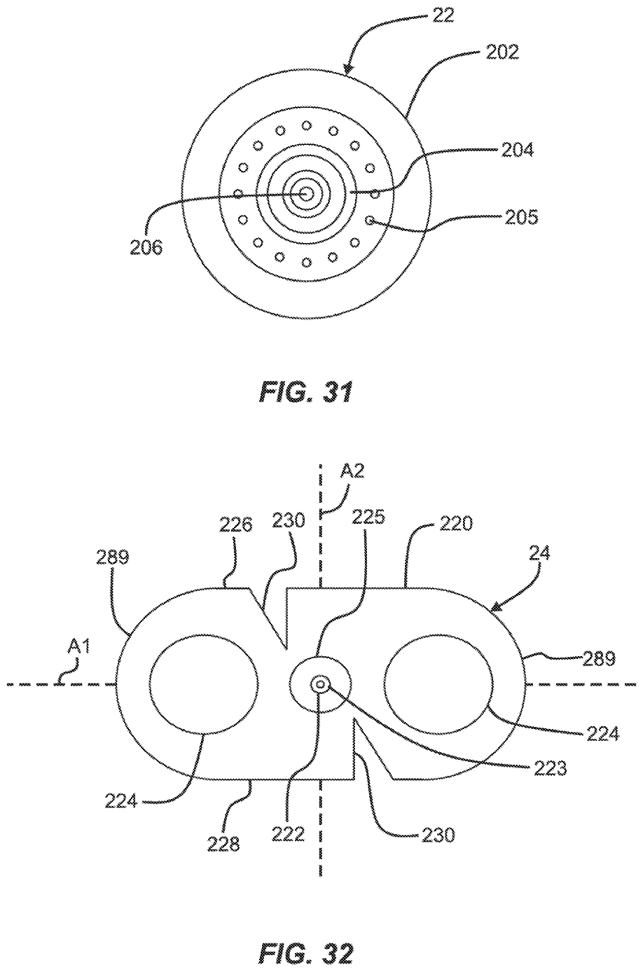

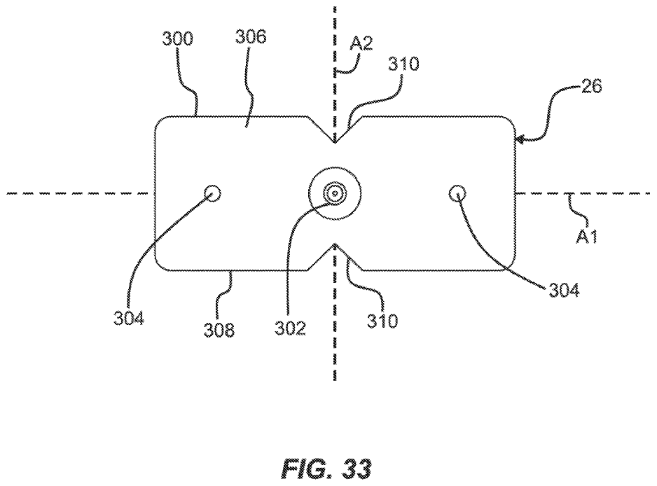

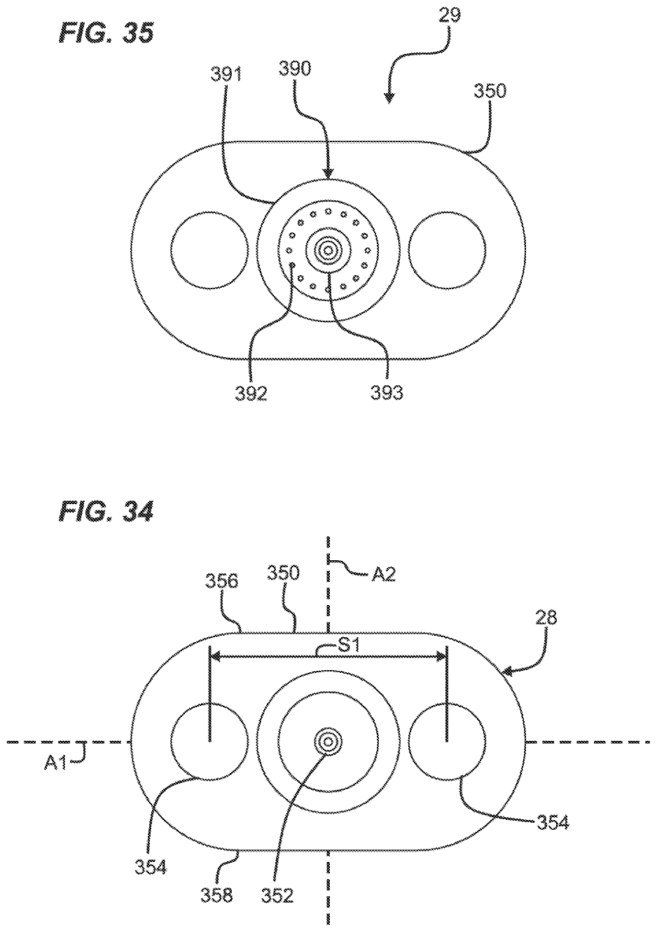

FIG. 1 illustrates an example fiber optic connector 20 in accordance with the principles of the present disclosure. Aspects of the present disclosure relate to different cable anchoring configurations for securing different styles of fiber-optic cables to the fiber optic connector 20. For example, FIGS. 3 and 13 depict an anchoring configuration for securing a first type of fiber-optic cable 22 (e.g., a round fiber optic cable (see FIG. 31) such as a 5 millimeter round cable) to the fiber optic connector 20. Also, FIGS. 14-21 depict anchoring configurations including end caps 240, 240a for securing a second type of fiber optic cable 24 (e.g., a flat drop cable (see FIG. 32) having a tearable jacket that can be torn to access an interior optical fiber of the cable) to the fiber-optic connector 20. Further, FIGS. 22-25 depicts an anchoring configuration including a cable anchoring clamp 27 for securing a third type of fiber optic cable 26 (e.g., a Figure-8 cable, see FIG. 33) to the fiber optic connector 20. Moreover, FIGS. 26-28 depict a cable anchoring end cap 31 that can be used to secure a fourth type of fiber optic cable 28 (e.g., a flat drop cable (see FIG. 34) that is larger than the second type of fiber optic cable 24) to the fiber optic connector 20. Further, FIGS. 28 and 29 depict a cable anchoring end cap 33 that can be used to secure a fifth type of fiber optic cable 29 (e.g., a flat drop cable (see FIG. 35) having an inner round cable) to the fiber optic connector 20.

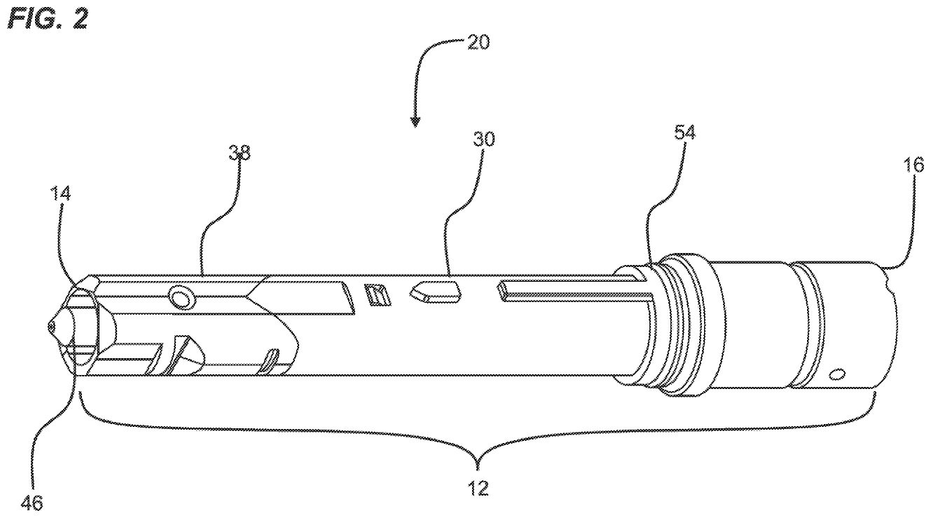

Referring to FIGS. 1 and 2, the fiber optic connector 20 includes a connector core including a core housing 12 having a front end 14 and a rear end 16. The core housing 12 includes a main core body 30, a rear spring stop 36 and a front plug body 38. The front plug body 38 includes a front end 38a and a rear end 38b. The main core body 30 includes a front end 30a and a rear end 30b. The front end 14 of the core housing 12 is defined by the front end 38a of the front plug body 38 and the rear end 16 of the core housing 12 is defined by the rear end 30b of the main core body 30. The rear spring stop 36 mounts at the front end 30a of the main core body 30 and the front plug body 38 mounts over the rear spring stop 36. A ferrule assembly 40 and a spring 42 are captured between the front plug body 38 and the rear spring stop 36 such that the spring 42 biases the ferrule assembly 40 forwardly relative to the front plug body 38. A non-hardened dust cap 44 is adapted to mount over a ferrule 46 of the ferrule assembly 40 and a hardened dust cap 48 is adapted to mount over the front end 14 of the core housing 12. The hardened dust cap 48 can function as a pulling-eye. A turn-to-secure fastener 50 (e.g., a rotational coupler) mounts over a rear end portion of the core housing 12. The turn-to-secure fastener 50 is adapted for securing the fiber optic connector 20 to other structures such as the hardened dust cap 48, an interface converter, another fiber optic connector, or a fiber optic adapter. An example adapter, example interface converters and example turn-to-secure fastener configurations are disclosed in PCT International Publication No. WO 2021/041305 which is hereby incorporated by reference in its entirety. A boot 52 for providing cable bend radius protection mounts on the turn-to-secure fastener 50. A shape memory sleeve 54 such as a heat shrink sleeve can mount over the rear end 16 of the core housing 12 and over a cable secured to the core housing 12 to provide sealing and securement between the rear end 16 of the core housing 12 and a jacket of the cable. An external seal 54 (e.g., an o-ring) mounts about an exterior of the core housing 12 for sealing with respect to the structure to which the fiber optic connector 20 is secured by the turn-to-secure fastener 50.

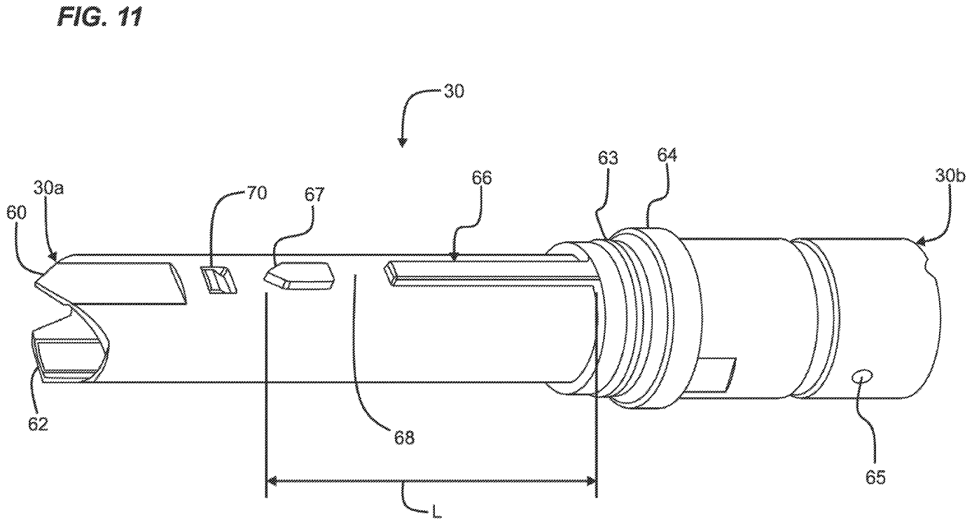

Referring to FIG. 11, the main core body 30 includes first and second forward projections 60, 62 located at the front end 30a of the main core body 30. The first and second forward projections 60, 62 are positioned opposite from one another on opposite sides of the main core body 30. The first and second forward projections 60, 62 can be configured to provide a keying function with respect to the front plug body 38 such that the front plug body 38 can only be mounted in one rotational position relative to the main core body 30. In one example, the first and second forward projections 60, 62 can have different shapes (e.g., profiles). For example, as depicted, the first forward projection 60 has a shape with a pointed end while the second forward projection 62 has a flat end. As depicted, the first forward projection 60 is triangular in shape while the second forward projection 62 is trapezoidal in shape. Alternatively, the second forward projection could be rectangular or square. In certain examples, the first and second forward projections 60, 62 have different projection lengths. For example, the first forward projection 60 is depicted having a longer projection length than the second forward projection 62.

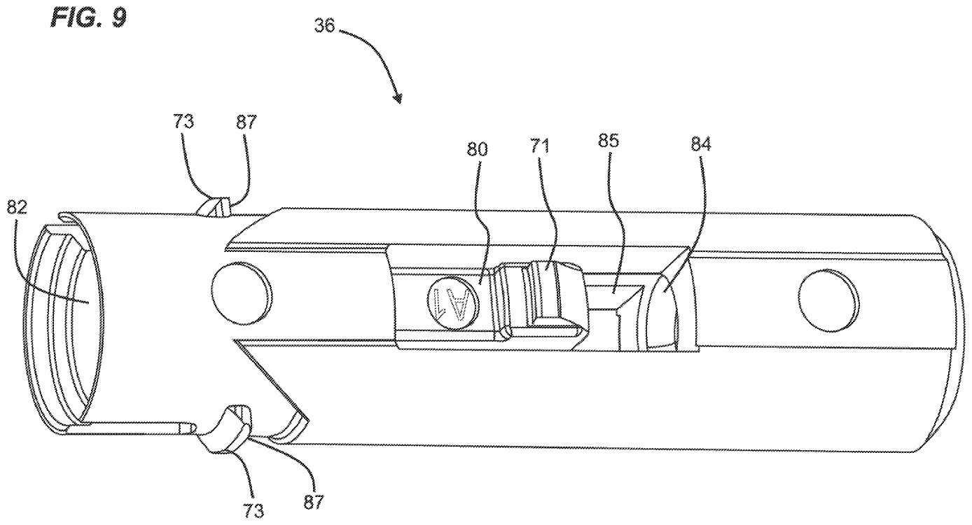

Referring still to FIG. 11, the main core body 30 defines a circumferential groove 63 for receiving the seal 54 and an outer circumferential shoulder 64 that functions as a forward stop for limiting forward movement of the turn-to-secure faster 50 relative to the main core body 30. The main core body 30 defines an adhesive injection port 65 adjacent the rear end 30b of the main core body 30 four allowing adhesive (e.g., epoxy) to be injected into the interior of the main core body 30 for securing a fiber-optic cable therein. The main core body 30 defines an elongate key 66 adapted to be received within a corresponding keyway of a structure such as a fiber-optic adapter or a converter to which the fiber optic connector 20 is coupled. The key 66 has a tapered front end 67 and includes a gap 68 (e.g., a break) at an intermediate location along the key 66. In one example, the key 66 has a length L that extends along at least 25% of a total length of the main core body 30. The key 66 is longitudinally aligned with the first forward projection 60. A latch opening 70 is positioned between the front end 67 of the key 66 and the first forward projection 60. In the depicted example, the latch opening 70 is positioned closer to the front end 67 of the key 66 than the first forward projection 60. The latching opening 70 is configured to receive a latch portion 71 of a latching cantilever arm 80 of the rear spring stop 36 (See FIG. 9). The latch portion 71 is positioned within a middle third of a length of the rear spring stop 36.

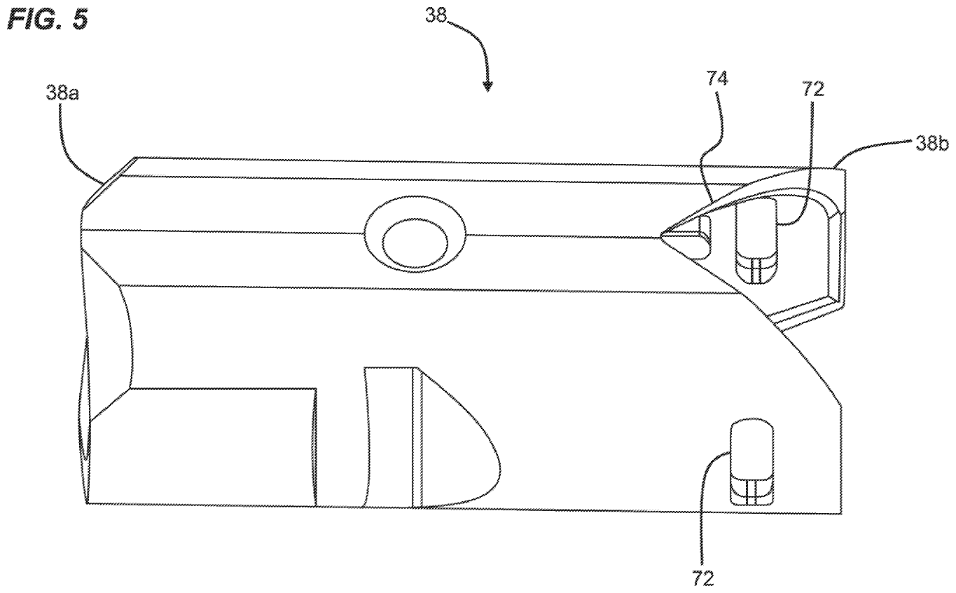

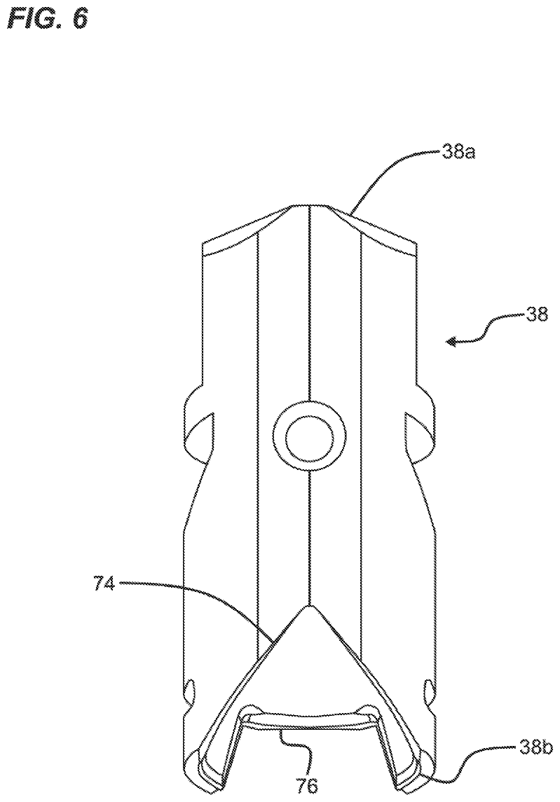

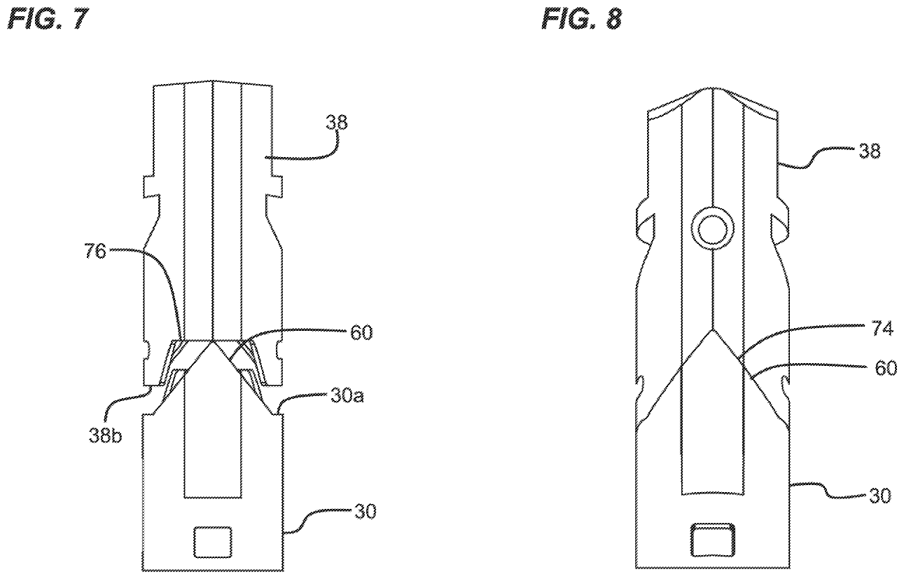

Referring to FIGS. 5-8, the front end 38a of the front plug body 38 defines a plug form factor depicted as having an SC connector plug form factor. Other form factors such as an LC connector form factor or other shapes can also be used. The front plug body 38 has an open front end through which the ferrule 46 objects when the fiber optic connector 20 is assembled. The rear end 38b of the front plug body 38 includes side the latch openings 72 adapted to receive latch members 73 of the rear spring stop 36 to secure the front plug body 38 to the front end 30a of the main core body 30. The rear end 38b of the front plug body 38 also includes first and second receivers 74, 76 for respectively receiving the first and second forward projections 60, 62 of the main core body 30 when the front plug body 38 is secured at the front end 30a of the main core body 30. The first and second receivers 74, 76 have different shapes adapted to respectively complement the shapes of the first and second forward projections 60, 62 to provide the keying function. In the depicted example, the first receiver 74 is deeper than the second receiver 76. In the depicted example, the first receiver 74 is triangular in shape while the second receiver 76 is trapezoidal in shape. It will be appreciated that the configuration of the first and second forward projections 60, 62 and the first and second receivers 74, 76 prevents the front plug body 38 from being mounted at the front end of the main core body 30 if the front plug body is in the incorrect orientation (see FIG. 7) and allow the front plug body 38 to be mounted at the front end of the main core body 30 if the front plug body is in the correct orientation (see FIG. 8).

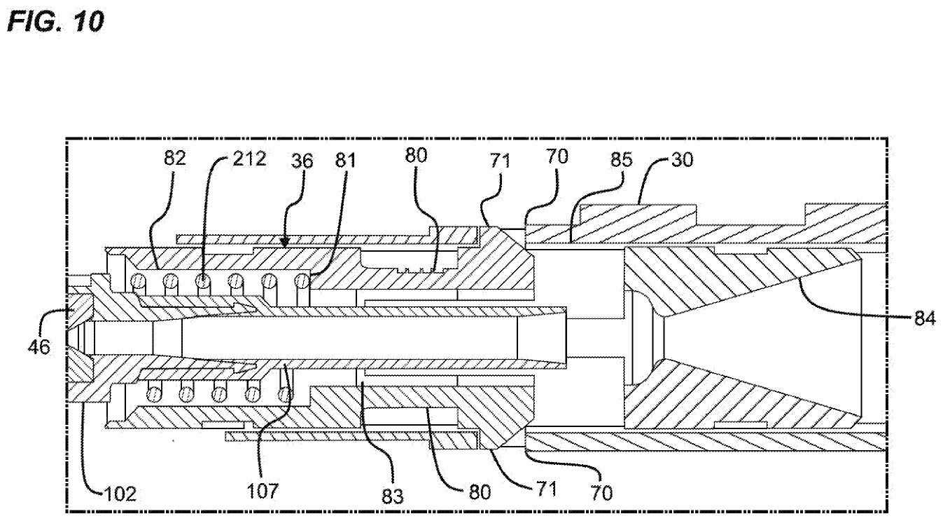

Referring to FIGS. 9 and 10, the rear spring stop 36 defines a front pocket 82 for receiving a rear end of the spring 42 when the fiber optic connector 20 is assembled. The pocket 82 is defined in part by a shoulder 81 that functions as a stop for the rear end of the spring 42. The rear spring stop 36 also includes a longitudinal through-passage 83 through which an optical fiber corresponding to a cable terminated to the fiber optic connector 20 can be routed. The through-passage 83 includes a tapered portion 84 at the rear end of the rear spring stop 36 for providing a funneling function for directing the optical fiber into the through-passage 83 during insertion of the optical fiber and its corresponding cable forwardly into the fiber optic connector 20. The tapered portion 84 has a major dimension at the rear end of the rear spring stop 36 and a minor dimension forwardly offset from the rear end of the rear spring stop 36. In one example, the tapered portion 84 has a truncated conical shape. A fiber insertion viewing window 85 is defined between a free end of the latching cantilever arm 80 and the minor end of the tapered portion 84. The latch members 73 of the rear spring stop 36 are located at opposite sides of the rear spring stop 36. In certain examples, the latch members 73 can have latching surfaces 87 oriented at an angle the range of 75 degrees to 85 degrees relative to a central longitudinal axis of the rear spring stop 36. The latching surfaces 87 are depicted angling forwardly as the latching surfaces 87 extend away from the central longitudinal axis of the rear spring stop 36.

The ferrule 46 of the ferrule assembly 40 defines a central fiber opening 100 in which the optical fiber corresponding to a fiber-optic cable anchored to the fiber optic connector 20 can be secured. In one example, the optical fiber is secured within the central fiber opening 100 by an adhesive potting material such as epoxy. The ferrule assembly 40 also includes a ferrule hub 102 mounted at a rear end of the ferrule 26. The ferrule hub 102 includes a front stop surface 104 that opposes a rear stop surface defined by a shoulder 106 within the front plug body 38 to retain the ferrule assembly 40 within the core housing 12. In the assembled connector 20, the spring 42 is captured between the ferrule hub 102 and the shoulder 81 of the rear spring stop 36. The ferrule assembly 40 further includes an extension sleeve 107 mounted on the ferrule hub 102. The extension sleeve 107 is configured to project rearwardly from the ferrule hub 102. The extension sleeve 107 can be configured to guide an optical fiber to the rear end of the ferrule 46 and into the central fiber opening 100 during the fiber insertion process. When the fiber optic connector 20 is assembled, a rear end of the extension sleeve 107 is located at the viewing window 85 of the rear spring stop 36 and is axially aligned with the minor end of the tapered portion 84. In certain examples, the main core body 20 can be constructed of a transparent material such that during routing of an optical fiber through the fiber optic connector the optical fiber can be viewed through the main core body 20 and the viewing window 85 as the optical fiber transitions from the tapered portion 84 of the rear spring stop to the rear end of the extension sleeve 107.

To assemble the fiber optic connector 20, the ferrule assembly 40 can be loaded into the front end of the rear spring stop 36 with the spring 42 captured between the ferrule hub 102 and the shoulder 81 of the rear spring stop 36. The front plug body 38 can then be installed at the front end of the rear spring stop 36 by inserting the front plug body 38 over the ferrule assembly 40 and snapping the latch members 73 of the rear spring stop 36 into the side latch openings 72 of the front plug body 38 to secure the front plug body 38 to the rear spring stop 36. In this way, the assembled front plug body 38, rear spring stop 36 and ferrule assembly 40 form a front pre-assembly. The rear spring stop 36 can then be inserted rearwardly through the front end 30a of the main core body 30 and latched within the main core body 30 by engagement between the latch opening 70 of the main core body 30 and the latch portion 71 of the latching cantilever arm 80 of the rear spring stop 36 to secure the front pre-assembly to the front end 30a of the main core body 30. In certain examples, the rear spring stop 36 can include two cantilever latching arms 80 including latch portions 71 that fir within latch openings 70 defined at opposite sides of the main core body 30.

The fiber optic connector 20 can be installed on a variety of different types of fiber optic cables. FIGS. 3 and 13 show the fiber optic connector 20 installed on the round cable 22. Referring to FIG. 31, the cable 22 include an outer jacket 202 surrounding an inner tube 204. A strength layer 205 (e.g., a layer of Aramid yarn and/or fiberglass) is positioned between the outer jacket 202 and the inner tube 204. An optical fiber 206 is positioned within the inner tube 204. The optical fiber 206 can include a glass core surrounded by a glass cladding layer. The optical fiber 206 can be coated. For example, a coating layer (e.g., acrylate) can be provided over the cladding layer and a polymeric buffer layer can surround the coating layer. To install the fiber optic connector 20 on the cable 22, the cable 22 can be prepared by stripping the outer jacket 202 such that the buffered optical fiber, the strength layer and the inner tube project beyond the jacket 202. The strength layer and the inner tube are trimmed to be shorter than the buffered optical fiber. The buffer layer and coating are stripped from the distal-most end of the buffered optical fiber to expose a bare glass portion of the optical fiber suitable to be inserted in the fiber opening of the ferrule 46. Epoxy can be dispensed in the ferrule 46 and the front pre-assembly can be assembled and installed at the front of the main core body 30. The prepared cable 22 can be inserted forwardly into the fiber optic connector through the rear end 16 of the core housing 12. During insertion, the distalmost end of the optical fiber 206 is guided into the extension sleeve 107 by the tapered portion 84 of the rear spring stop 36. Proper insertion of the optical fiber 206 can be visually confirmed through the viewing window 85. The extension sleeve 107 guides the optical fiber 206 into the fiber passage of the ferrule 46. When inserted, a bare fiber portion (e.g., a portion including only the cladding and core) of the optical fiber 206 is bonded within the ferrule 46 and a buffered portion of the fiber extends up to the back end of the ferrule 46. Once the epoxy cures, a portion of the optical fiber projecting beyond the ferrule can be cleaved and the cleaved end of the fiber as well and the end face of the ferrule can be processed (e.g., via polishing). The cable can be anchored at the rear of the core housing 12 by injecting epoxy into the core housing 12 through the injection port 65 to bond the exposed strength layer 205 and end of the cable 22 in place relative to the core housing 12. A shape memory sleeve (e.g., heat shrink sleeve 54) containing heat activated adhesive can be provided over the interface between the rear end 16 of the connector core housing 12, and the cable jacket 202 to provided additional sealing and reinforcement. Further, a tapered boot (e.g., boot 52) can be mounted over the shape memory sleeve at the junction where the cable enters the connector core housing 12 to provide bend radius protection to the cable.

In an alternative method installation method, the cable 22 can be inserted forwardly through the core housing 12 prior to mounting the front pre-assembly to the front end of the main core body 30. Once the cable is inserted through the main core body 30, the end of the cable can be prepared and the optical fiber 206 can be loaded into and bonded within the ferrule 46 of the front pre-assembly. The end the fiber 206 can then be processed and after processing the front preassembly can be secured to the front end of the main core body 30. Thereafter, the cable 22 can be anchored to the main core body 30 by bonding the cable to the rear end of the main core body via epoxy injected through the injection port 65.

FIGS. 14-16 depict the fiber optic connector 20 installed on the fiber optic cable 24. Referring to FIG. 32, the fiber optic cable 24 includes a cable jacket 220 in which an optical fiber 222 and first and second reinforcing members 224 are positioned. The optical fiber 222 can include a fiber core and a cladding layer surrounding the fiber core. As depicted a coating layer 223 and a tight buffer layer 225 surround the cladding layer. The cable jacket 220 has an elongate transverse cross-sectional shape that is longer along a major axis A1 of the transverse cross-sectional shape than along a minor axis A2 of the transverse cross-sectional shape. The transverse cross-sectional shape has first and second major sides 226, 228 that extend along the major axis A1. The first and second reinforcing members 224 are positioned at the major axis A1 with the optical fiber 222 being located between the first and second reinforcing members 224. In one example, the reinforcing members 224 are rods such as fiber-glass reinforced polymeric rods. Tear notches 230 are defined at the first and second major sides 226, 228. The tear notches 230 provide a weakened region that allows the jacket 220 to be diagonally torn through a passage in the jacket containing the optical fiber 222 to access the optical fiber 222. One of the notches 230 is provided at each of the major sides 226, 228 with the notches being located on a diagonal reference line that intersects the buffered optical fiber 222.

The fiber optic connector 20 can be installed on the fiber optic cable 24 in a similar manner as the cable 22 but with the additional step of using a cable anchoring end cap 240 to facilitate anchoring the cable 22 to the rear end 16 of the core housing 12 (e.g., the rear end 30b of the main core body 30). During installation, the cable anchoring end cap 240 can be slid onto the cable 24 prior to inserting the cable 24 into the core housing 12 and can be slid up the cable 24 and into engagement with the rear end 16 of the core housing 12 after insertion of the cable 24. The end cap 240 is then bonded in place with respect to the core housing 12 when epoxy is injected into the core housing 12 through the injection port 65 to bond the reinforcing members 224 within the rear end 16 of the core housing 12.

Referring to FIGS. 14-19, the cable anchoring end cap 240 mounts at the rear end 16 of the connector core housing 12 and is adapted for assisting in securing the fiber optic cable 24 to the connector core housing 12. The cable anchoring end cap 240 includes a main cap body 242 including a front side 244 and a rear side 246. The cable anchoring end cap 230 also includes first and second rearward extensions 248, 250 that project rearwardly from the main cap body 242 and respectively oppose the first and second major sides 226, 228 of the fiber optic cable 24. The cable anchoring end cap 240 also includes first and second forward extensions 252, 254 that project into the rear end 16 of the connector core housing 12. The first and second forward extensions 252, 254 are positioned opposite from one another and are separated by a gap 256 coinciding with the adhesive injection port 65 defined through the connection core housing 12. In this way, adhesive can be injected into an interior of the connector core housing between the first and second forward extensions 252, 254. The optical fiber 222 and the first and second reinforcing members 224 extend axially through the cable anchoring end cap 240 between the first and second forward extensions 252, 254. The first and second strength reinforcing members 224 are adhesively bonded within the connector core housing 12 by the adhesive (e.g., epoxy) injected through the injection port 65.

The cable anchoring end cap 240 is loaded into the connector core housing 12 by inserting the first and second forward extensions 252, 254 forwardly into the rear end 16 of the connector core housing 12. The first and second forward extensions 252, 254 include latch portions 260 that engage a forwardly facing inner shoulder structure 262 defined within the connector core housing 12 adjacent the rear end 16 of the connector core housing 12. The first and second forward extensions 252, 254 have transverse cross-sectional shapes that curve circumferentially about a central longitudinal axis 262 of the cable anchoring end cap 240. The main cap body 242 defines a circular outer shape and includes a forwardly facing annular surface 264 at the front side of the main cap body 242 that opposes a rearwardly facing surface 266 of the rear end 16 of the connector core housing 12 to stop forward movement of the end cap 240 relative to the core housing 12 during forward insertion.

The main cap body 242 further comprises a forwardly projecting tapered annular transition 270 that tapers radially inwardly from an inner diameter 271 (e.g., an inner circumference) of the forwardly facing annular surface 266 as the forwardly projecting tapered annular transition 270 extends in a forward direction. The inner diameter 271 of the forwardly facing annular surface 266 also coincides with a major diameter (e.g., a major circumference) of the tapered annular transition 270. The first and second forward extensions 252, 254 are at a minor diameter 272 (e.g., a minor circumference) of the forwardly projecting tapered annular transition 270 located at a forward end of the forwardly projecting tapered annular transition 270.

The fiber optic cable 24 includes the tear notches 230 at the first and second major sides 226, 228 of the fiber optic cable 24 that extend longitudinally along the fiber optic cable 24. The first and second rearward extensions 248, 250 include projections 282 that fit within the tear notches 230 at the first and second major sides 226, 228 of the fiber optic cable 24. The tear notches 230 and the projections 282 are depicted having matching triangular transverse cross-sectional shapes. The main cap body 242 further includes a rearwardly projecting tapered transition 284 that tapers radially inwardly from an outer circumference of the main cap body 242 as the rearwardly projecting tapered annular transition 284 extends in a rearward direction. The first and second rearward extensions 248, 250 project rearwardly from the rearwardly projecting tapered transition 284. An elongate recess 286 for receiving an end of the cable jacket 220 is defined within the rearwardly projecting tapered annular transition 284. Curved notches 288 are defined in the rearwardly projecting tapered annular transition 284 for receiving minor ends 289 of the transverse cross-sectional shape of the cable jacket 220.

The main cap body 242 also defines a central opening 290 for receiving the buffered optical fiber 222 of the fiber optic cable 24. The main cap body 242 also defines first and second reinforcing member openings 291 for respectively receiving the first and second reinforcing members 224 of the fiber optic cable 24. The central opening 290 is positioned between the first and second reinforcing member openings 291.

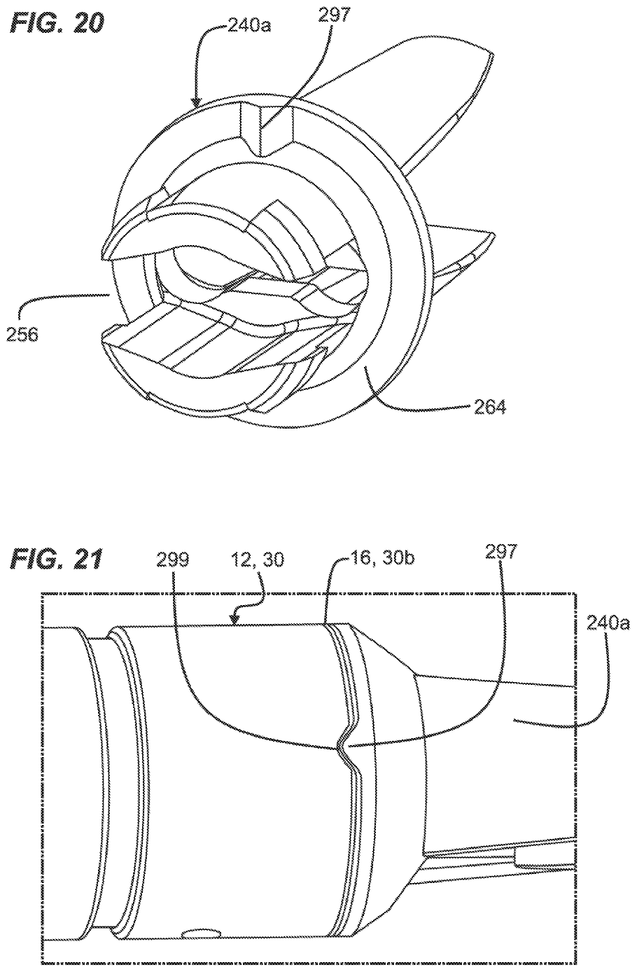

FIGS. 20 and 21 depict an alternative cable anchoring end cap 240a having the same construction as the cable anchoring end cap 240 except a keying projection 297 has been provided at the forwardly facing annular surface 264 for fitting within a corresponding notch 299 provided at the rear end 16 of the connector core housing 12. The intermating of the projection 297 and the notch 299 ensures that the end cap 240a is mounted to the connector core housing 12 at a predetermined rotational orientation (e.g., with the gap 256 aligned with the injection port 65 defined by the connector core housing 12) relative to the core housing 12.

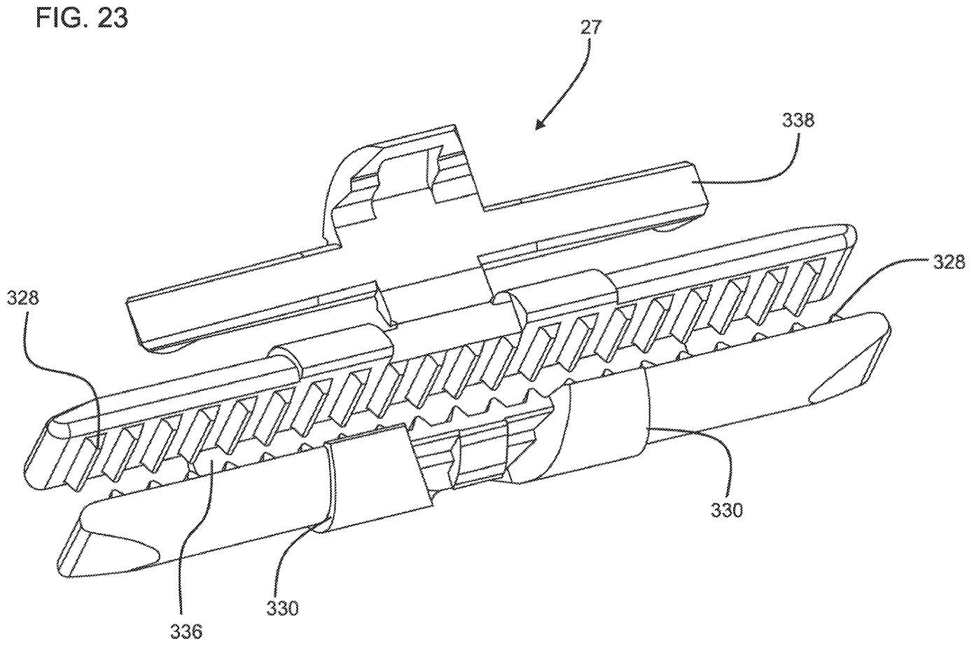

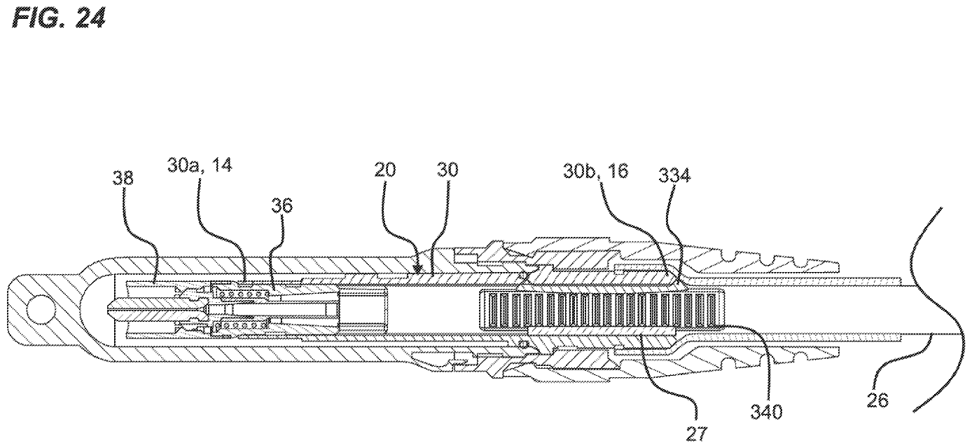

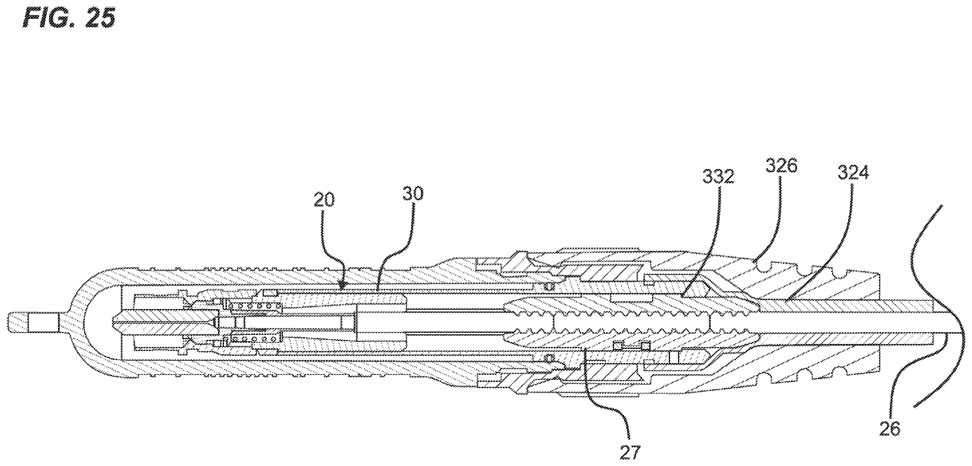

FIGS. 24 and 25 depict the fiber optic connector 20 installed on the fiber optic cable 26 using the cable anchoring clamp 27 of FIGS. 22 and 23 to anchor the cable 26 with respect to the connector core housing 12. Referring to FIG. 33, the fiber optic cable 26 including a cable jacket 300 in which an optical fiber 302 and first and second reinforcing members 304 are positioned. The cable jacket 300 has a Figure-8 cable configuration and has an elongate transverse cross-sectional shape that is longer along a major axis A1 of the transverse cross-sectional shape than along a minor axis A2 of the transverse cross-sectional shape. The transverse cross-sectional shape has first and second major sides 306, 308 that extend along the major axis A1. The first and second reinforcing members 304 are positioned at the major axis A1 with the optical fiber 302 being located between the first and second reinforcing members 304. In one example, the reinforcing members are rods such as fiber-glass reinforced polymeric rods. Tear notches 310 are defined at the first and second major sides 306, 308. The centrally located tear notches 310 provide a weakened region that allows the jacket 300 to be torn through a passage in the jacket containing the optical fiber 302 to access the optical fiber 222.

Referring to FIGS. 22 and 23, the cable anchoring clamp 27 includes first and second clamp portions 320, 322 between which the cable 27 is clamped. The cable anchoring clamp 27 is configured such that the first and second clamp portions 320, 322 are compressed together via contact with an interior of the main core body 30 to clamp the fiber optic cable 26 (e.g., the jacket of the cable 26) when the cable anchoring clamp 27 is loaded into the main core body 30 while mounted on the fiber optic cable 26. The cable anchoring clamp 27 is installed by: a) inserting the cable 26 forwardly through the main core body 30 while the front pre-assembly is disengaged from the front end 30a of the main core body 30; b) prepping the end of the cable 26 and installing and processing the optical fiber 22 in the ferrule 46 of the front pre-assembly; c) mounting the cable anchoring clamp 27 on a portion of the fiber optic cable 26 located forward of the front end 30a of the main core body 30; d) pulling the fiber optic cable 26 rearwardly relative to the main core body 30 to move the cable anchoring clamp 27 mounted on the cable 26 into the main core body 30 wherein the first and second clamp portions 320, 322 are compressed together within the main core body 30 to clamp the fiber optic cable 26 as the fiber optic cable 26 is pulled rearwardly; and e) mounting the front pre-assembly at the front end 30a of the main core body 30 after the cable anchoring clamp 27 has been pulled rearwardly into the main core body 30. A shape memory sleeve 324 (e.g., a heat shrink sleeve containing heat activated adhesive) and a flexible boot 326 can be slid over the cable 26 prior to inserting the cable 26 through the main body 30. Once the cable anchoring clamp 27 is installed within the main body 30, the shape memory sleeve 324 can be installed over the junction between the main body 30 and the cable 26 and bonded to the main body 30 and the cable jacket (e.g., using a heat shrink process and the heat activated adhesive within the sleeve). The boot 326 can then be installed over the shape memory sleeve 324.

As depicted, the first and second clamp portions 320, 322 have teeth 328 that engage the cable jacket 300 during clamping. The cable anchoring clamp 27 is also depicted including a rearwardly facing stop 330 that engages a forwardly facing stop 332 within the main core body 30 to stop rearward movement of the cable anchoring clamp 27 relative to the main core body 30 when the cable is pulled rearwardly to compress the cable anchoring clamp 27 within the main core body 30. The cable anchoring clamp includes a latch 334 that engages the main core body 30 (e.g., the rear end 30b of the main core body 30) to resist forward movement of the cable anchoring clamp 27 relative to the main core body 30 when the cable anchoring clamp 27 is fully rearwardly positioned in the main core body 30. The clamp 27 can be symmetrical about a transverse mid-line and the latch 334 can have a symmetrical double latch configuration (e.g., including latches 334a, 334b) such that installation of the clamp 27 onto the cable 26 is not orientation dependent (the clamp 27 can be mounted with either end positioned rearwardly). As shown at FIG. 23, first sides of the first and second clamping portions 320, 322 are connected by an interconnect portion 336 and wherein a hinged cover 338 is located at opposite second sides of the first and second clamping portions 320, 322. The hinged cover 338 is moveable between an open position see FIG. 23 and a closed position (see FIG. 24). When in the closed position, the cover 338 blocks an open side of the clamp 27 positioned opposite from the interconnect portion 336 and is adapted for capturing the cable 26 within an interior of the clamp 27 between the clamping portions 320, 322. When the cover 338 is in the open position, the cable 26 can be inserted through the open side into the clamp 27. The latch 334 is integrated with the hinged cover 338. When the clamp 27 is latched within the main core body 30, a rear portion 340 of the clamp 27 projects rearwardly beyond the rear end 16 connector core housing 12.

FIGS. 26-28 depict the cable anchoring end cap 31 for use in anchoring the fiber optic cable 28 of FIG. 34 to the fiber optic connector 20. The fiber optic cable 28 includes a cable jacket 350 in which an optical fiber 352 and first and second reinforcing members 354 are positioned. The cable jacket 350 has a flat drop cable configuration and has an elongate transverse cross-sectional shape that is longer along a major axis A1 of the transverse cross-sectional shape than along a minor axis A2 of the transverse cross-sectional shape. The transverse cross-sectional shape has first and second major sides 356, 358 that extend along the major axis A1. The first and second reinforcing members 354 are positioned at the major axis A1 with the optical fiber 352 being located between the first and second reinforcing members 354. In one example, the first and second reinforcing members 354 (i.e., strength members) are rods such as fiber-glass reinforced polymeric rods. As depicted the optical fiber 352 is depicted as a coated optical fiber which in certain examples, has an outer diameter less than or equal to about 250 microns.

The cable anchoring end cap 31 is configured to mount at the rear end 16 of the connector core housing 12 and is adapted for assisting in securing the fiber optic cable 28 to the rear end 16 of the connector core housing 12. Referring to FIGS. 26-28, the cable anchoring end cap 31 includes a main cap body 360 including a front side 362 and a rear side 364. The cable anchoring cap 31 also includes first and second rearward extensions 366, 368 that project rearwardly from the main cap body 360 and are adapted to respectively oppose the first and second major sides 356, 358 of the fiber optic cable 28. Gripping ribs are provided at inner surfaces of the rearward extensions 366, 368 for engaging the first and second major sides 356, 358. The cable anchoring end cap 31 also includes first and second forward extensions 370, 372 adapted to project into the rear end 16 of the connector core housing 12.

Referring to FIG. 34, the first and second reinforcing members 354 have a first center-to-center spacing S1 within the cable jacket 350. The main cap body 360 defines first and second reinforcing member openings 374 for respectively receiving the first and second reinforcing members 354 of the fiber optic cable 28. The first and second reinforcing member openings 374 have a second center-to-center spacing S2 adjacent a forward portion of the main cap body 360 that is smaller than the first center-to-center spacing S1. When the cable 28 is anchored to the rear end 16 of the connector body core 12 with the assistance of the end cap 31, the first and second reinforcing members 354 transition from the first center-to-center spacing S1 to the second center-to-center spacing S2 as the first and second reinforcing members 354 extend forwardly through the cable anchoring end cap 31. This transition is advantageous because it allows the main core body 30 to receive the reinforcing members 354 even though the spacing S1 is larger than the interior opening of the main core body 30. An elongate pocket 376 having a shape that matches the elongate cross-sectional profile of the cable jacket 350 is defined at a rearward portion of the main cap body 360. The main cap body 360 includes an inner sleeve 378 that defines a central opening 380 for receiving the optical fiber 352 of the fiber optic cable 28. The central opening 380 is positioned between the first and second reinforcing member openings 374. The central opening 380 is tapered such that a cross-dimension of the central opening 380 reduces as the central opening 380 extends forwardly from a major diameter at the rearward end 382 to a minor diameter at the forward end 384. The major diameter can be sized such that the rearward end 382 can receive a forward end of a protective tube 386 of the cable 28 which surrounds the optical fiber 352. The minor diameter can be sized to be slightly larger than the outer diameter of the fiber 352. The main cap body 360 can define an adhesive injection port 388 for injecting adhesive such as epoxy into the reinforcing member openings 374 and into the interior of the connector core housing 12 to adhesively anchor the cable 28 and the end cap 31 to the rear end 12 of the connector core housing 12. The connector 20 can be vertically oriented with the front end 14 facing upwardly at the time the adhesive is injected into the end cap 31 and the connector core housing 12. The connector core housing 12 can be transparent to allow for the visual inspection and monitoring of the adhesive injected into the connector core housing 12 to visually confirm a fill level of the adhesive.

FIGS. 29 and 30 depict the cable anchoring end cap 33 for use in anchoring the fiber optic cable 29 of FIG. 35 to the fiber optic connector 20. The fiber optic cable 29 has the same construction as the fiber optic cable 28, except a round inner cable 390 is positioned within the cable jacket 350. The inner cable 390 includes a cable jacket 391 containing a strength layer 392 (e.g., Aramid yard and/or fiber glass) and a buffered optical fiber 393. In one example, the buffered optic fiber has an outer diameter greater than 500 microns (e.g., 700 microns or 900 microns). The cable anchoring end cap 33 has the same construction as the cable anchoring end cap 31 except: a) an enlarged pocket 394 is provided at the rearward end 382 of the inner sleeve 378 for receiving an end portion of the inner cable (e.g., the cable jacket 391 and the strength layer 392); b) side openings 395 are defined through the inner sleeve 278 (e.g., through the wall defining the enlarged pocket 394) that provide communication between the central opening 380 and the first and second reinforcing member openings 374 to allow adhesive injected through the adhesive injection port 388 to flow to the strength layer 392 to provide bonding of the strength layer 392; and c) the minor diameter at the forward end 384 of the inner sleeve 372 is enlarged to accommodate the buffered optical fiber 393.

### ASPECTS OF THE DISCLOSURE

Aspect 1. A fiber optic connector comprising: a connector core housing including a main core body and a front assembly that mounts at a front end of the main core body, the front assembly including a ferrule assembly and a spring captured between a front plug body and a rear spring stop.

Aspect 2. The fiber optic connector of Aspect 1, further comprising a turn-to-secure fastener that mounts over a rear end portion of the connector core housing for securing the fiber optic connector to other structures such as a hardened dust cap, an interface converter, another fiber optic connector, or a fiber optic adapter.

Aspect 3. The fiber optic connector of any of the above Aspects, further comprising an external seal that mounts about an exterior of the core housing.

Aspect 4. The fiber optic connector of any of the above Aspects, wherein the front plug body connects to the rear spring stop by a first snap-fit connection, and wherein where rear spring stop connects to the front end of the main core body by a second snap-fit connection for securing the front assembly to the main core body.

Aspect 5. The fiber optic connector of any of the above Aspects, further comprising different types of end caps that are mountable to a rear end of the main core body to accommodate different types of fiber optic cables.

Aspect 6. The fiber optic connector of any of the above Aspects, wherein the main core body includes first and second forward projections located at the front end of the main core body, the first and second forward projections being positioned opposite from one another on opposite sides of the main core body, the first and second forward projections being configured to provide a keying function with respect to the front plug body such that the front assembly can only be mounted in one rotational position relative to the main core body.

Aspect 7. The fiber optic connector of Aspect 6, wherein the first and second forward projections have different shapes.

Aspect 8. The fiber optic connector of Aspect 7, wherein the first forward projection has a shape with a pointed end while the second forward projection has a flat end.

Aspect 9. The fiber optic connector of Aspect 7, wherein the first forward projection is
triangular in shape while the second forward projection is trapezoidal in shape.

Aspect 10. The fiber optic connector of any of Aspects 7-9, wherein one of the first and second forward projections has a longer projection length than the other of the first and second forward projections.

Aspect 11. The fiber optic connector of Aspect 10, wherein the first forward projection has a longer projection length than the second forward projection.

Aspect 12. The fiber optic connector of any of Aspects 1-11, wherein the main core body defines an adhesive injection adjacent a rear end of the main core body.

Aspect 13. The fiber optic connector of any of Aspects 1-12, wherein the main core body defines an elongate key adapted to be received within a corresponding keyway of a structure such as a fiber-optic adapter or a converter to which the fiber optic connector is coupled.

Aspect 14. The fiber optic connector of Aspect 13, wherein the key has a tapered front end and includes a gap at an intermediate location along the key.

Aspect 15. The fiber optic connector of Aspect 13, wherein the key is longitudinally aligned with the first forward projection.

Aspect 16. The fiber optic connector of Aspect 15, further comprising a latch opening positioned between a front end of the key and the first forward projection for receiving a latch portion of the rear spring stop.

Aspect 17. The fiber optic connector of Aspect 16, wherein the latch opening is positioned closer to the front end of the key than the first forward projection.

Aspect 18. The fiber optic connector of Aspect 16 or 17, wherein the latch portion is formed with a longitudinally extending cantilever arm of the rear spring stop, and wherein the latch portion is positioned within a middle third of a length of the rear spring stop.

Aspect 19. The fiber optic connector of any of Aspects 1-18, wherein the ferrule assembly includes a ferrule defining an optical fiber opening, a ferrule hub mounted at a rear end of the ferrule, and an elongate fiber sleeve mounted on the ferrule hub that extends rearwardly from the ferrule hub in alignment with the optical fiber opening.

Aspect 20. The fiber optic connector of Aspect 19, wherein the spring extends over the elongate fiber sleeve and is captured between the ferrule hub and a stop provided on the rear spring stop.

Aspect 21. The fiber optic connector of Aspect 20, wherein the rear spring stop defines a front pocket for receiving a rear end of the spring when the fiber optic connector is assembled, wherein the pocket is defined in part by a shoulder that functions as a stop for the rear end of the spring, wherein the rear spring stop also includes a longitudinal through-passage through which an optical fiber corresponding to a cable terminated to the fiber optic connector can be routed, wherein the through-passage includes a tapered portion at the rear end of the rear spring stop for providing a funneling function for directing the optical fiber into the through-passage during insertion of the optical fiber and its corresponding cable forwardly into the fiber optic connector, wherein the tapered portion has a major dimension at the rear end of the rear spring stop and a minor dimension for the offset from the rear end of the rear spring stop, and wherein the rear spring stop defines a fiber insertion viewing window between a free end of the cantilever arm and the minor end of the tapered portion.

Aspect 22. The fiber optic connector of Aspect 21, wherein a rear end of the elongate fiber sleeve is viewable through the insertion viewing window.

Aspect 23. The fiber optic connector of Aspect 22, wherein the main core body is transparent at least at the insertion viewing window.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A fiber optic connector and cable assembly comprising:
a connector core housing having a front end and a rear end, the front end defining a connector plug end of the fiber optic connector;
a fiber optic cable including a cable jacket in which an optical fiber and first and second reinforcing members are positioned, the cable jacket having an elongate transverse cross-sectional shape that is longer along a major axis of the transverse cross-sectional shape than along a minor axis of the transverse cross-sectional shape, the transverse cross-sectional shape having first and second major sides that extend along the major axis, the first and second reinforcing members being positioned at the major axis with the optical fiber being located between the first and second reinforcing members;
a cable anchoring end cap mounted at the rear end of the connector core housing for securing the fiber optic cable to the connector core housing, the cable anchoring end cap including a main cap body including a front side and a rear side, the cable anchoring end cap also including first and second rearward extensions that project rearwardly from the main cap body and respectively oppose the first and second major sides of the fiber optic cable, the cable anchoring end cap also including first and second forward extensions that project into the rear end of the connector core housing, the first and second forward extensions being positioned opposite from one another and being separated a gap, the gap coinciding with an adhesive injection port defined through the connection core housing for allowing adhesive to be injected to an interior of the connector core housing between the first and second forward extensions, the optical fiber and the first and second strength members extending axially through the cable anchoring end cap and between the first and second forward extensions, the first and second strength members being adhesively bonded within the connector core housing by the adhesive injected through the injection port.

2. The fiber optic connector and cable assembly of claim 1, wherein the cable anchoring end cap is loaded into the connector core housing by inserting the first and second forward extensions forwardly into the rear end of the connector core housing, and wherein the first and second forward extensions include latch portions that engage a forwardly facing inner shoulder structure defined within the connector core housing adjacent the rear end of the connector core housing.

3. The fiber optic connector and cable assembly of claim 1, wherein the first and second forward extensions have transverse cross-sectional shapes that curve circumferentially about a central longitudinal axis of the cable anchoring end cap.

4. The fiber optic connector and cable assembly of claim 1, wherein the main cap body defines a circular outer shape and includes a forwardly facing annular surface at the front side of the main cap body that opposes a rearwardly facing surface of the rear end of the connector core housing.

5. The fiber optic connector and cable assembly of claim 4, wherein the main cap body further comprises a forwardly projecting tapered annular transition that tapers radially inwardly from an inner diameter of the forwardly facing annular surface as the forwardly projecting tapered annular transition extends in a forward direction, the inner diameter of the forwardly facing annular surface coincides with a major diameter of the forwardly projecting tapered annular transition, wherein the first and second forward extensions are at a minor diameter of the forwardly projecting tapered annular transition located at a forward end of the forwardly projecting tapered annular transition.

6. The fiber optic connector and cable assembly of claim 1, wherein the fiber optic cable includes tear notches at the first and second major sides of the fiber optic cable that extend longitudinally along the fiber optic cable, and wherein the first and second rearward extensions include projections that fit within the tear notches at the first and second major sides of the fiber optic cable.

7. The fiber optic connector and cable assembly of claim 6, wherein the tear notches and the projections have triangular transverse cross-sectional shapes.

8. The fiber optic connector and cable assembly of claim 1, wherein the main cap body further comprises a rearwardly projecting tapered transition that tapers radially inwardly from an outer circumference of the main cap body as the rearwardly projecting tapered annular transition extends in a rearward direction, wherein the first and second rearward extensions project rearwardly from the rearwardly projecting tapered transition, and wherein an elongate recess for receiving an end of the cable jacket is defined within the rearwardly projecting tapered transition.

9. The fiber optic connector and cable assembly of claim 8, wherein curved notches are defined in the rearwardly projecting tapered transition for receiving minor ends of the transverse cross-sectional shape of the cable jacket.

10. The fiber optic connector and cable assembly of claim 1, wherein the main cap body defines a central opening for receiving the optical fiber of the fiber optic cable, wherein the main cap body also defines first and second strength member openings for respectively receiving the first and second strength members of the fiber optic cable, and wherein the central opening being positioned between the first and second strength member openings.

11. A fiber optic connector and cable assembly comprising:
a connector core housing having a front end and a rear end, the front end defining a connector plug end of the fiber optic connector;
a fiber optic cable including a cable jacket in which an optical fiber and first and second reinforcing members are positioned, the cable jacket having an elongate transverse cross-sectional shape that is longer along a major axis of the transverse cross-sectional shape than along a minor axis of the transverse cross-sectional shape, the transverse cross-sectional shape having first and second major sides that extend along the major axis, the first and second reinforcing members being positioned at the major axis with the optical fiber being located between the first and second reinforcing members;
a cable anchoring end cap mounted at the rear end of the connector core housing for securing the fiber optic cable to the connector core housing, the cable anchoring end cap including a main cap body including a front side and a rear side, the cable anchoring cap also including first and second rearward extensions that project rearwardly from the main cap body and respectively oppose the first and second major sides of the fiber optic cable, the cable anchoring end cap also including first and second forward extensions that project into the rear end of the connector core housing;
wherein the first and second strength members have a first center-to-center spacing within the cable jacket, wherein the main cap body defines first and second strength member openings for respectively receiving the first and second strength members of the fiber optic cable, wherein the first and second strength member openings have a second center-to-center spacing adjacent a forward portion of the main cap body that is smaller than the first center-to-center spacing, and wherein the first and second strength members transition from the first center-to-center spacing to the second center-to-center spacing as the first and second strength members extend forwardly through the cable anchoring end cap.

12. The fiber optic connector and cable assembly of claim 11, wherein the main cap body includes an inner sleeve that defines a central opening for receiving the optical fiber of the fiber optic cable, and wherein the central opening is positioned between the first and second strength member openings.

13. The fiber optic connector and cable assembly of claim 12, wherein the inner sleeve defines side openings that provide communication between the central opening and the first and second strength member openings.

14. The fiber optic connector and cable assembly of claim 12, wherein the central opening is tapered such that a cross-dimension of the central opening reduces as the central opening extends forwardly.

15. The fiber optic connector and cable assembly of claim 12, wherein the main cap body defines a cavity having an elongate cross-sectional shape sized for receiving an end of the cable jacket.

16. The fiber optic connector and cable assembly of claim 14, wherein a round protective tube of the cable that surrounds the optical fiber fits within an outer end of the central opening.

17. A fiber optic connector and cable assembly comprising:
a connector core housing having a front end and a rear end, the front end defining a connector plug end of the fiber optic connector;
a fiber optic cable including a cable jacket in which an optical fiber and first and second reinforcing members are positioned, the cable jacket having an elongate transverse cross-sectional shape that is longer along a major axis of the transverse cross-sectional shape than along a minor axis of the transverse cross-sectional shape, the transverse cross-sectional shape having first and second major sides that extend along the major axis, the first and second reinforcing members being positioned at the major axis with the optical fiber being located between the first and second reinforcing members;
a cable anchoring end cap mounted at the rear end of the connector core housing for securing the fiber optic cable to the connector core housing;
wherein the first and second strength members have a first center-to-center spacing within the cable jacket, and wherein the first and second strength members transition from the first center-to-center spacing to a second center-to-center spacing that is smaller than the first center-to-center spacing as the first and second strength members extend forwardly through the cable anchoring end cap.

18. A fiber optic connector and cable assembly comprising:
a connector core housing having a front end and a rear end, the connector core housing including a main core body and a front plug body, the main core body including a front end and a rear end, the front plug body being mountable at the front end of the main core body to define the front end of the connector core housing;
a fiber optic cable including a cable jacket in which an optical fiber is positioned;
a cable anchoring clamp for anchoring the fiber optic cable within the connector core housing, the cable anchoring clamp including first and second clamp portions between which the cable is clamped, wherein the cable anchoring clamp is configured such that the first and second clamp portions are compressed together via contact with an interior of the main core body to clamp the fiber optic cable when the cable anchoring clamp is loaded into the main core body while mounted on the fiber optic cable, wherein the cable anchoring clamp is installed by: a) inserting the cable forwardly through the main core body while the front plug body is disengaged from the front end of the main core body; b) mounting the cable anchoring clamp on a portion of the fiber optic cable located forward of the front end of the main core body; c) pulling the fiber optic cable rearwardly to move the cable anchoring clamp mounted thereon into the main core body wherein the first and second clamp portions are compressed together within the main core body to clamp the fiber optic cable as the fiber optic cable is pulled rearwardly; and d) mounting the front plug body at the front end of the main core body after the cable anchoring clamp has been pulled rearwardly into the main core body.

19. The fiber optic connector and cable assembly of claim 18, wherein the first and second clamp portions have teeth that engage the cable jacket during clamping.

20. The fiber optic connector and cable assembly of claim 18, wherein the cable anchoring clamp includes a rearwardly facing stop that engages a forwardly facing stop within the main connector core to stop rearward movement of the cable anchoring clamp relative to the main connector core.

21. The fiber optic connector and cable assembly of claim 20, wherein the cable anchoring clamp includes a latch that engages the main connector core to resist forward movement of the cable anchoring clamp relative to the main connector core when the cable anchoring clamp is fully rearwardly positioned in the main connector core.

22. The fiber optic connector and cable assembly of claim 18, wherein first sides of the first and second clamping portions are connected by an interconnect portion and wherein a hinged cover is located at opposite second sides of the first and second clamping portions.

23. The fiber optic connector and cable assembly of claim 20, wherein the cable anchoring clamp includes a portion that projects rearwardly beyond the connector core housing.

24. The fiber optic connector and cable assembly of claim 20, further comprising a shape memory sleeve that mounts over and bonds to the rear end of the connector core housing and the cable jacket.
